(19) United States
(12) Patent Application Publication
(10) Pub. No.: US 2016/0292288 A1
(43) Pub. Date: Oct. 6, 2016

(54) COMMENTS ANALYZER

(71) Applicant: Linkedin Corporation, Mountain View, CA (US)

(72) Inventors: Mariah E. Walton, Sunnyvale, CA (US); Haipeng Li, Mountain View, CA (US)

(21) Appl. No.: 14/675,532

(22) Filed: Mar. 31, 2015

(51) Int. Cl. G06F 17/30

(52) U.S. Cl. CPC G06F 17/30876; G06F 17/30616

(57) ABSTRACT

Systems and methods for evaluating members' comments in a social networking based system are disclosed. A social networking system receives a content item, from a first client system, for inclusion in a first database associated with a social networking system. The system receives a request from a second client system, wherein the request specifies a specific content item and one or more related comments. The system accesses comments associated with the content item, wherein the one or more comments are stored in a second database associated with the social networking system. The system analyzes each comment to generate a comment relevance score. The system selects a predetermined number of comments based on the comment relevance score for each comment in the one or more comments. The system transmits the requested content item and the predetermined number of selected comments to the second client system.

### TECHNICAL FIELD

The disclosed example embodiments relate generally to the field of computer-based social networks and, in particular, to a system for analyzing member-submitted content.

### BACKGROUND

The rise of the computer age has resulted in increased access to personalized services online. As the cost of electronics and networking services drops, many services that were previously provided in person are now provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly.

One area that has improved dramatically as computer technology has improved is online social networking sites. The services provided by online social networking sites allow members to build and maintain personal and business relationships in a much more comprehensive and manageable manner. In addition, members can create and share content with each other and provide feedback to content created by others.

### DESCRIPTION OF THE DRAWINGS

Some example embodiments are illustrated by way of example and not limitation in the figures of the accompanying drawings, in which:

FIG. 1 is a network diagram depicting a client-server system that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIG. 4A is a member interface diagram illustrating an example of a member interface, according to some example embodiments.

FIG. 4B is a member interface diagram illustrating an example of a member interface, according to some example embodiments.

FIG. 5 depicts a block diagram of an exemplary data structure for content item data in accordance with some example embodiments.

FIG. 6 is a flow diagram illustrating a method, in accordance with some example embodiments, for using large data sets to analyze member comments in a social networking system environment.

FIGS. 7A-7B are flow diagrams illustrating a method, in accordance with some example embodiments, for using large data sets to analyze member comments in a social networking system (e.g., system 120 in FIG. 1) environment.

FIG. 8 is a block diagram illustrating architecture of software, which may be installed on any one or more of devices, in accordance with some example embodiments.

FIG. 9 is a block diagram illustrating components of a machine, according to some example embodiments.

Like reference numerals refer to corresponding parts throughout the drawings.

### DETAILED DESCRIPTION

The present disclosure describes methods, systems, and computer program products for using large data sets to analyze and rank member comments in a social networking environment. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

Social networking sites allow members to create and share content with the members. Members can write posts, update status, blog, share videos, as part of the social networking experiences. Other members can then interact with the shared content in a plurality of ways, including, but not limited to, liking, following, sharing, and commenting. In some example embodiments, member comments themselves create interesting and worthwhile discussion around a specific content item. However, the number of comments on a popular content item can quickly exceed the number that a particular member can realistically process.

In some example embodiments, when a member requests to view the comments associated with a content item, the social networking system can analyze the comments to identify the most worthwhile comments for each content item.

In some example embodiments, comment quality can be determined by analyzing the length of the comments (e.g., comments that are too short or very long typically have lower quality), the number of replies or likes, and the inclusion of determined keywords.

In some example embodiments, keywords for a topic can be determined by analyzing the content item itself and/or the text of all the comments. The social networking system can then identify popular words (e.g., words that occur often, while ignoring very commonplace words). In some example embodiments, once one or more keywords are identified, each respective comment can be analyzed to determine whether the respective comment includes one or more keywords, how many instances, and so on.

In some example embodiments, the social networking system can also determine the quality of comments from a specific point of view. For example, Member A requests the comments for a content item. The social networking system determines one or more social contacts for Member A (e.g., members with which Member A is connected). In some example embodiments, the social networking system can then increase scores for comments that originate from members of Member A's social contacts.

In some example embodiments, the keywords can be determined based only on comments that originate from a given member's social contacts. In addition, the social networking system can increase the score of comments that have replies from a requesting member's social contacts.

In some example embodiments, the comments are ranked based on the determined quality scores. The social networking system then selects a predetermined number of comments based on the ranking. For example, the social networking system selects the top five comments based on comment quality score.

In some example embodiments, the social networking system then transmits the requested content item and the selected comments to the requesting client system for display on a display associated with the client system.

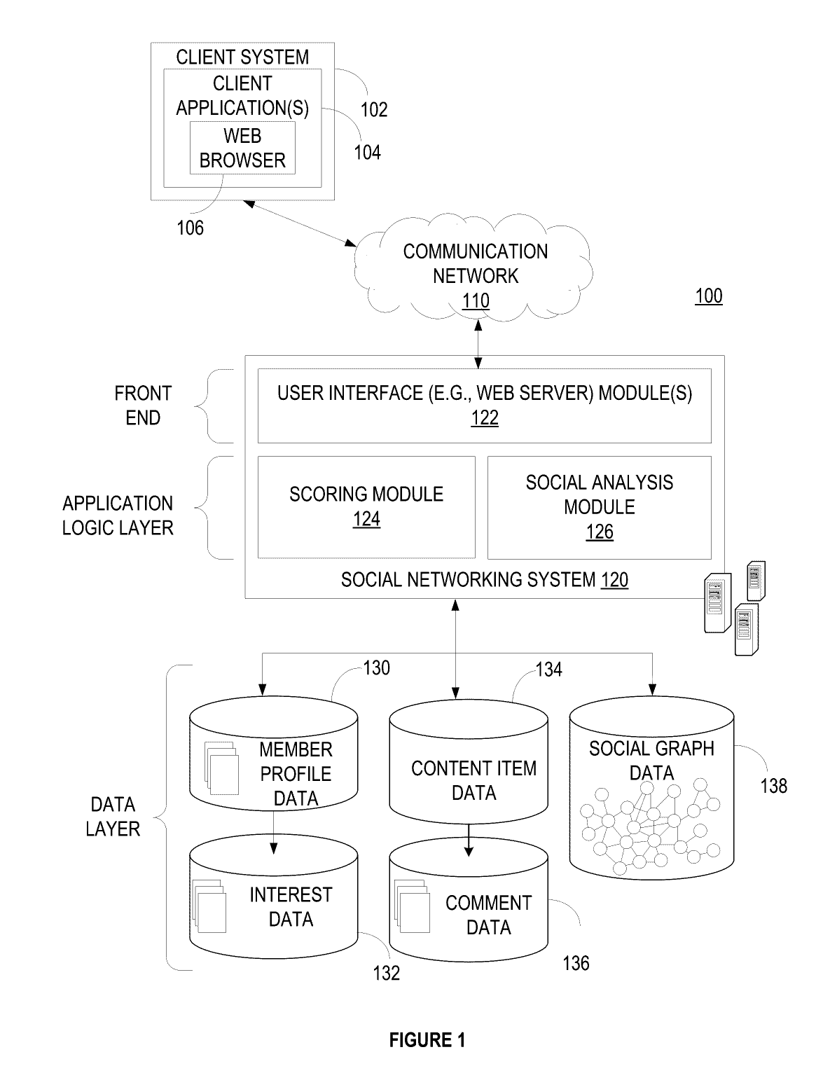

FIG. 1 is a network diagram depicting a client-social networking system environment 100 that includes various functional components of a social networking system 120, in accordance with some example embodiments. The client-social networking system environment 100 includes one or more client systems 102, and a social networking system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser 106. The client system 102 uses the web browser 106 to communicate with the social networking system 120 and displays information received from the social networking system 120.

In some example embodiments, the client system 102 includes an application specifically customized for communication with the social networking system 120 (e.g., a LinkedIn iPhone application). In some example embodiments, the social networking system 120 is a server system that is associated with a social networking service. However, the social networking system 120 and the server system that actually provides the social networking service may be completely distinct computer systems.

In some example embodiments, the client system 102 sends a request to the social networking system 120 for a webpage associated with the social networking system 120. For example, a member uses a client system 102 to log into the social networking system 120 and clicks a link to send a request to the social networking system 120 for information about a content item on a social networking webpage. In response, the client system 102 receives the requested data (e.g., a blog post and associated comments) and displays them on the client system 102.

In some example embodiments, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various example embodiments are by no means limited to this architecture.

As shown in FIG. 1, the front end consists of a user interface module (e.g., a web server) 122, which receives requests from various client systems 102 and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser 106 applications or applications that have been developed for a specific platform to include any of a wide variety of mobile devices and operating systems.

As shown in FIG. 1, the data layer includes several databases, including databases for storing data for various members of the social networking system 120, including member profile data 130, interest data 132 (e.g., data describing the interests of one or more members of the social networking system 120), content item data 134, comment data 136 (e.g., data that contains all comments associated with all content items shared through the social networking system 120), and social graph data 138, which is data stored in a particular type of database that uses graph structures with nodes, edges, and properties to represent and store data. Of course, with various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some example embodiments, when a person initially registers to become a member of the social networking system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes interest data 132. In other example embodiments, the interest data 132 is distinct from, but associated with, the member profile data 130. The interest data 132 stores data detailing one or more interests for members of the social networking system 120 including topics of interest to the member, hobbies, sports teams, companies, technology products, non-government organizations, search history, likes, follows, content rating, and so on. In some example embodiments, this information is only tracked with member permission.

The content item data 134 includes all data needed to present one or more content items stored for member use on the social networking system 120. Content items include, but are not limited to, posts, updates, blogs, videos, images, audio files, graphics, and so on. For example, if a content item were a member blog post, the content item data 134 is the text and formatting information for that blog post. In another example, if the content item is a video, the content item data 134 is the data a computer device needs to display that video (e.g., stored in an .MP4 or .AVI file).

In some example embodiments, the comment data 136 stores the text (and other information) for comments associated with content items stored in the content item data 134. Thus, whenever a member wants to leave a comment about a content item, the comment is stored in the comment data 136. In some example embodiments, comment data 136 also includes information about when comments were submitted, the member who submitted them, how many (and which) members liked (or up-voted) the comment, the relationship between comments (e.g., whether a given comment is in reply to another comment), and so on.

Once registered, a member may invite other members, or be invited by other members, to connect via the network service. A “connection” may include a bi-lateral agreement by the members, such that both members acknowledge the establishment of the connection. Similarly, with some example embodiments, a member may elect to “follow” another member. In contrast to establishing a “connection,” the concept of “following” another member typically is a unilateral operation and, at least with some example embodiments, does not include acknowledgement or approval by the member that is being followed. When one member follows another, the member who is following may receive automatic notifications about various activities undertaken by the member being followed. In addition to following another member, a member may elect to follow a company, a topic, a conversation, or some other entity, which may or may not be included in the social graph. Various other types of relationships may exist between different entities and are represented in the social graph data 138.

The social networking system 120 may provide a broad range of other applications and services that allow members the opportunity to share and receive information, often customized to the interests of the member. In some example embodiments, the social networking service may include a photo sharing application that allows members to upload and share photos with other members. As such, at least with some example embodiments, a photograph may be a property or entity included within a social graph. With some example embodiments, members of a social networking service may be able to self-organize into groups, or interest groups, organized around a subject matter or topic of interest. In some example embodiments, the data for a group may be stored in a database. When a member joins a group, his or her membership in the group will be reflected in the organization activity data, the member activity data, and the social graph data 138.

In some example embodiments, the application logic layer includes various application server modules, which, in conjunction with the user interface module(s) 122, generate various user interfaces (e.g., web pages) with data retrieved from various data sources in the data layer. With some example embodiments, individual application server modules are used to implement the functionality associated with various applications, services, and features of the social networking service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. Of course, other applications or services that utilize a scoring module 124 or a social analysis module 126 may be separately implemented in their own application server modules.

In addition to the various application server modules, the application logic layer includes a scoring module 124 and/or a social analysis module 126. As illustrated in FIG. 1, with some example embodiments, the scoring module 124 or the social analysis module 126 are implemented as services that operate in conjunction with various application server modules. For instance, any number of individual application server modules can invoke the functionality of the scoring module 124 or the social analysis module 126. However, with various alternative example embodiments, the scoring module 124 and the social analysis module 126 may be implemented as their own application server modules such that they operate as stand-alone applications. With some example embodiments, the scoring module 124 or the social analysis module 126 include or have an associated publicly available API that enables third-party applications to invoke the functionality they provide.

Generally, the scoring module 124 uses information about a comment to generate a comment quality score for a given comment in a group of comments. In some example embodiments, the content quality score is based on analysis of metadata of the comment including the length of the comment, the number of replies to the comment, the time the comment was posted, and so on. For example, in some example embodiments, medium length comments are generally scored higher than short comments or very long comments.

In another example, comments can be weighted based on the time that the comment was received relative to the time that the comment viewing request was received such that more recent comments are weighted more heavily than comments that are less recent. Thus, if a media content item has received comments over a two-year period, the most recent comments will be more likely to receive high content quality scores.

In some example embodiments, the scoring module 124 analyzes the content of the comments to determine comment quality scores. In some example embodiments, the scoring module 124 determines one or more keywords for comments associated with a particular content item. In some example embodiments, the scoring module 124 determines keywords by analyzing the text (if any) of the content item (e.g., the text of a blog post or closed captioning data for a video) and/or the text of all the comments. Words that are commonly used (except common words such as “the” or “a”) in the comments and the content item are determined to be keywords. In some example embodiments, the keywords are determined based on the difference between the word frequencies in the comments and in the language in general.

In some example embodiments, once keywords are determined, the scoring module 124 generates comment quality scores based, at least in part, on the number of keywords included in the comments. Thus, if a comment includes all the relevant keywords, it will generally be scored higher than a comment with no keywords.

In some example embodiments, the scoring module 124 will access the social analysis module 126 to use the social connections of members to generate comment quality scores using social connection.

In some example embodiments, the social analysis module 126 uses social graph data 138 for members to improve the scores generated by the scoring module 124. In some example embodiments, the social analysis module 126 receives a comment viewing request (e.g., a member selects a “Comments” link below a content item) from a first member. In some example embodiments, the social analysis module 126 determines one or more members that are connected to the first member through the social graph data 138.

In some example embodiments, the social analysis module 126 will increase the scores from comments that have authors that are connected to the first member. In some example embodiments, the comment quality scores from a respective member will be increased proportionally to the degree to which the respective member is connected to the first member. For example, if the respective member is three degrees separated from the first member, the score increase will be lower than a respective member that is a first degree connection to the first member.

In some example embodiments, the social analysis module 126 will determine the social connections of the author of the content item and increase the comment quality scores of comments originating from members with a social connection to the author of the content item.

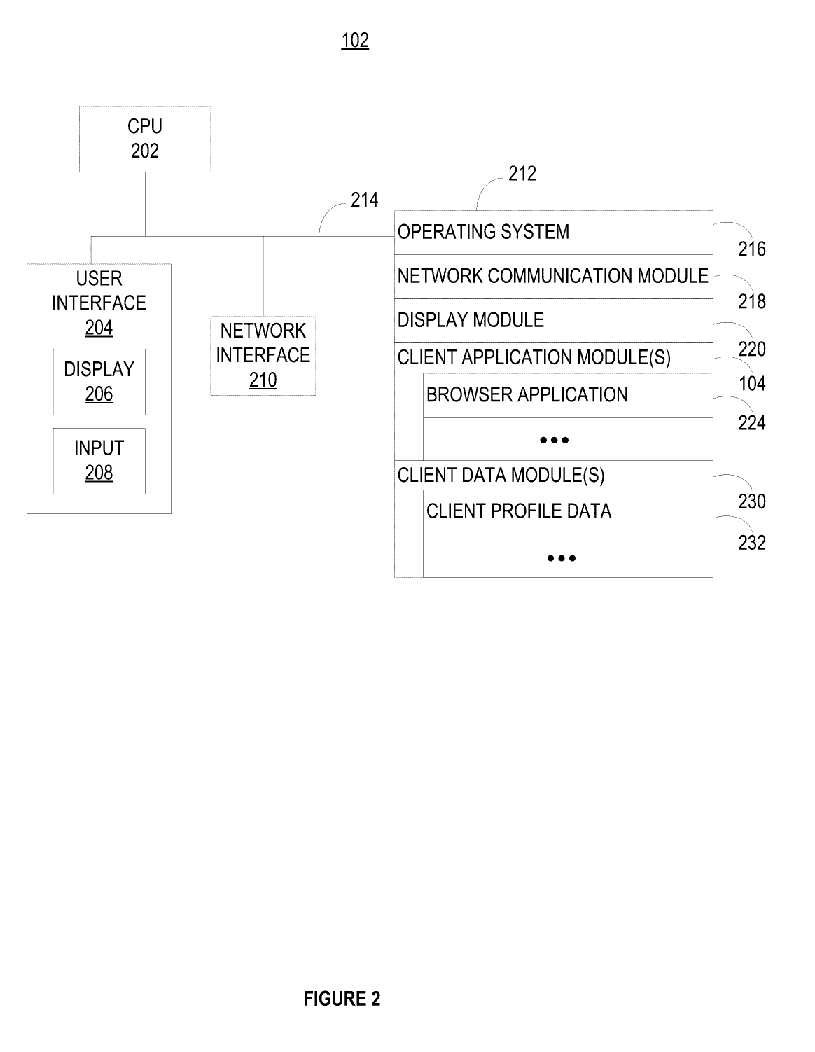

FIG. 2 is a block diagram further illustrating the client system 102, in accordance with some example embodiments. The client system 102 typically includes one or more central processing unit (CPU) 202, one or more network interface 210, memory 212, and one or more communication bus 214 for interconnecting these components. The client system 102 includes a user interface 204. The user interface 204 includes a display device 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer-readable storage medium.

In some example embodiments, memory 212, or the computer-readable storage medium of memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more communication network interfaces 210 (wired or wireless) and one or more communication networks 110, such as the Internet, other WANs, LANs, metropolitan area networks (MANs), etc.;
a display module 220 for enabling the information generated by the operating system 216 and client application(s) 104 to be presented visually on the display device 206;
one or more client application 104 for handling various aspects of interacting with the social networking system 120 (FIG. 1), including but not limited to:
   a browser application 224 for requesting information from the social networking system 120 (e.g., product pages and member information) and receiving responses from the social networking system 120; and
client data module(s) 230 for storing data relevant to the clients, including but not limited to:
   client profile data 232 for storing profile data related to a member of the social networking system 120 associated with the client system 102.

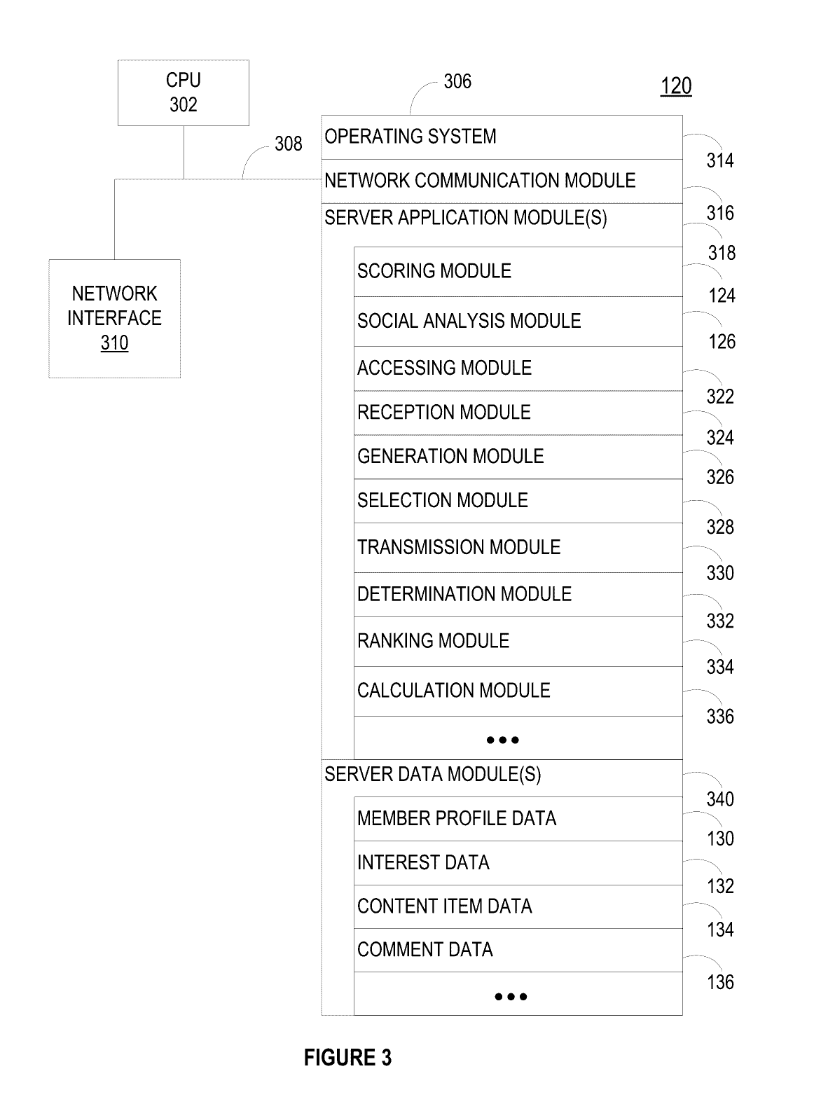

FIG. 3 is a block diagram further illustrating the social networking system 120, in accordance with some example embodiments. The social networking system 120 typically includes one or more CPU 302, one or more network interface 310, memory 306, and one or more communication bus 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer-readable storage medium. In some example embodiments, memory 306, or the computer-readable storage medium of memory 306, stores the following programs, modules, and data structures, or a subset thereof:
an operating system 314 that includes procedures for handling various basic system services and for performing hardware-dependent tasks;
a network communication module 316 that is used for connecting the social networking system 120 to other computers via the one or more communication network interface 310 (wired or wireless) and one or more communication network 110, such as the Internet, other WANs, LANs, MANs, and so on;
one or more server application module 318 for performing the services offered by the social networking system 120, including but not limited to:
   a scoring module 124 for generating comment quality scores that represent the importance of a comment; in some example embodiments the scoring module 124 generates customized comment quality scores for each requesting member based on that member's history, social connection, interests, and so on;
   a social analysis module 126 for using a member's social connections (e.g., stored in the social graph data 138) to help customize comment quality scores for that member;
   an accessing module 322 for accessing stored data about content items and the comments associated with each content item stored in the content item data 134;
   a reception module 324 for receiving a request from a client system associated with a member of the social networking system 120;
   a generation module 326 for generating a comment quality score for a plurality of comments;
   a selection module 328 for selecting one or more comments, based on the comment quality scores, to transmit to the requesting member, wherein, in some cases, the comment quality scores are personalized to the specific requesting member based on their interests and their social connections;
   a transmission module 330 for transmitting data, including a content item and one or more selected comments, to a client system (e.g., system 102 in FIG. 1);
   a determination module 332 for determining information about a respective comment, including, but not limited to, the length of a comment, the data a comment was submitted, the author of the comment (e.g., the member who submitted the comment), and so on;
   a ranking module 334 for generating a ranking order for one or more comments based on the comment quality score associated with each comment; and
   a calculation module 336 for calculating word frequencies in a text (e.g., the text of all the comments associated with a specific content item); and
server data module(s) 340, holding data related to social networking system 120, including but not limited to:
   member profile data 130 including both data provided by the member who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on member activity, social graph data, overall trend data for the social networking system 120, and so on;
   interest data 132 including data representing a member's stated or inferred interest in one or more topics;
   content item data 134 including data for one or more content items (e.g., videos, posts, images, blogs, and so on); and
   comment data 136 including data for all comments submitted for content items in the social networking system 120.

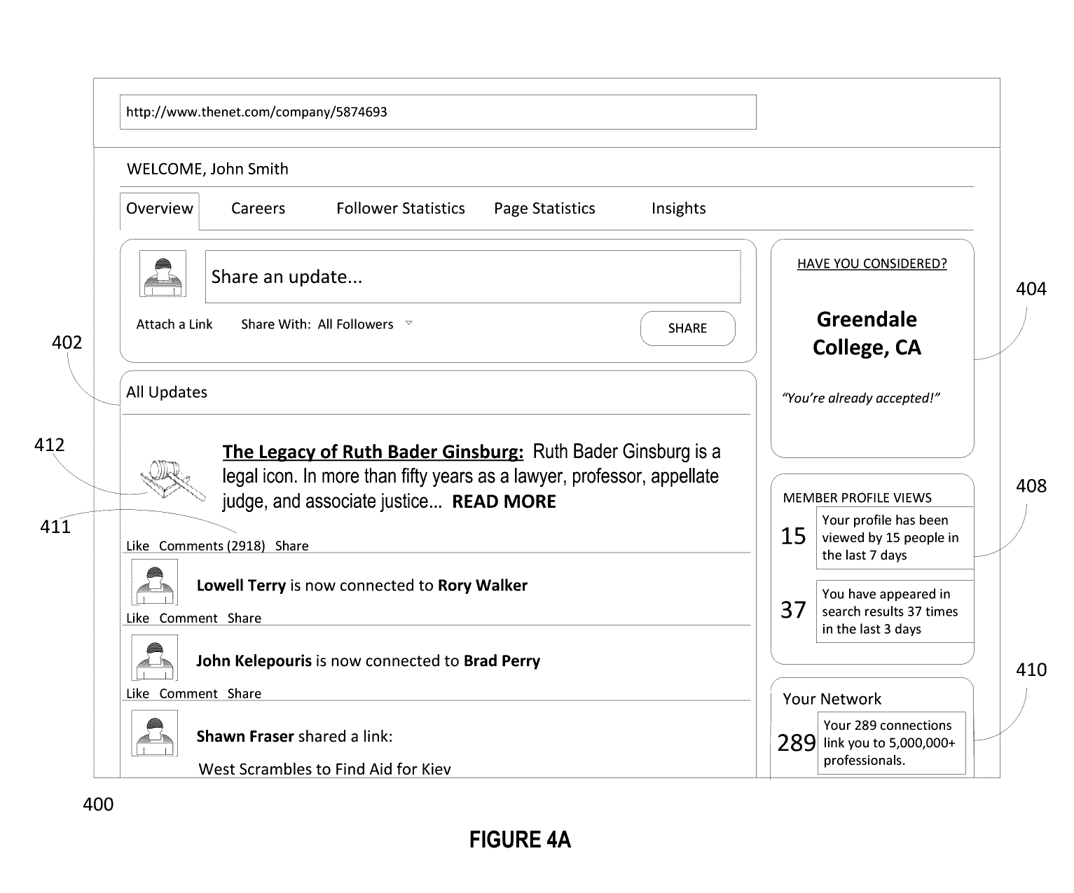

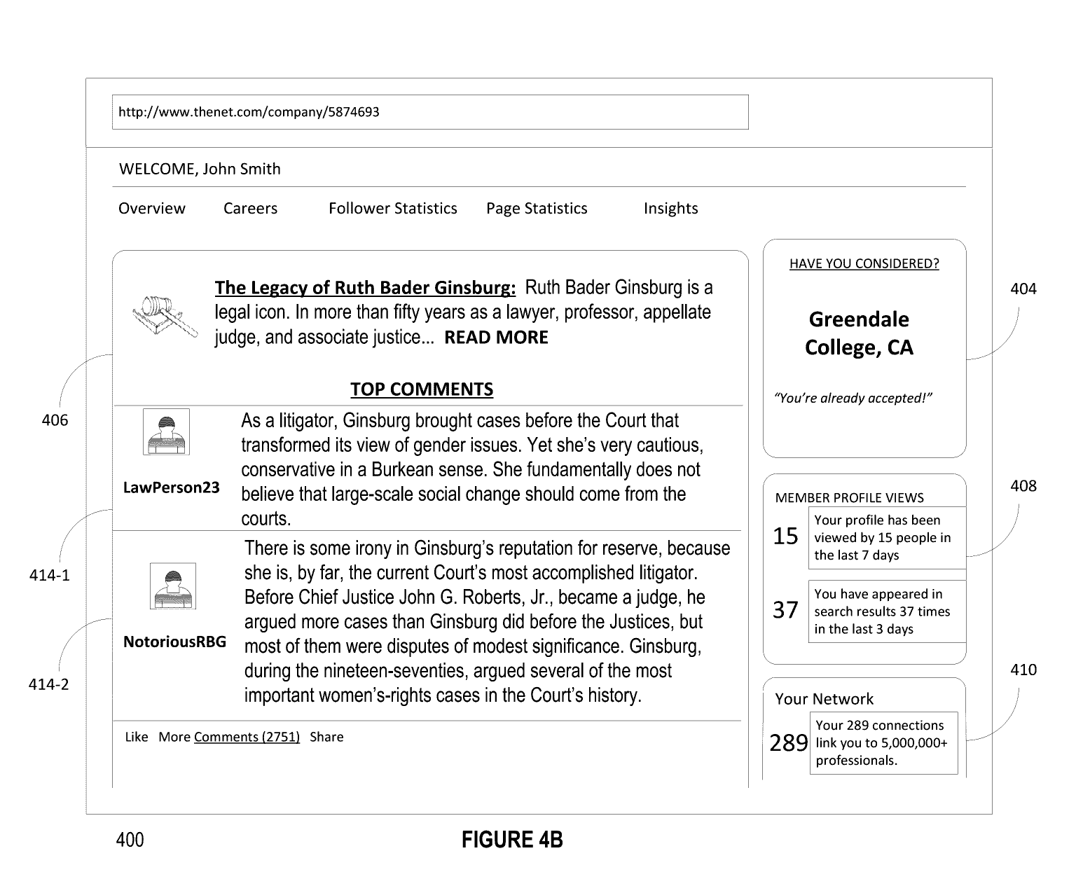

FIG. 4A is a member interface diagram illustrating an example of a user interface 400 in accordance with some example embodiments. The user interface 400 has a stream of updates 402 for the user, including, but not limited to, notifications of new social connections, status updates, and content shared by other members.

In addition, the generated webpage includes an advertisement 404. In some example embodiments, by clicking on the advertisement 404, the client system (e.g., system 120 in FIG. 1) will receive additional information about the advertised product or service.

The user interface 400 also includes information in side sections of the interface 400 including a contact recommendation section, profile viewership statistic section 408, and a social graph statistic section 410.

In some example embodiments, the user interface 400 includes one or more content items 412. In this example, the content item 412 is a blog post about Ruth Bader Ginsburg. In some example embodiments, the content item 412 also includes a link 411 to member comments about the content item 412. In some example embodiments, the member can click the link 411 to open a list of comments associated with the content item 412.

FIG. 4B is a member interface diagram illustrating a further example of the user interface 400 in accordance with some example embodiments. The user interface 400 has a content item 406, one or more comments 414-1 and 414-2 associated with the content item 406 (e.g., after the link 411 has been selected), profile viewership statistic section 408, and a social graph statistic section 410.

In some example embodiments, the displayed comments (414-1 to 414-2) are the comments to be calculated as the most important for the displayed content item 406.

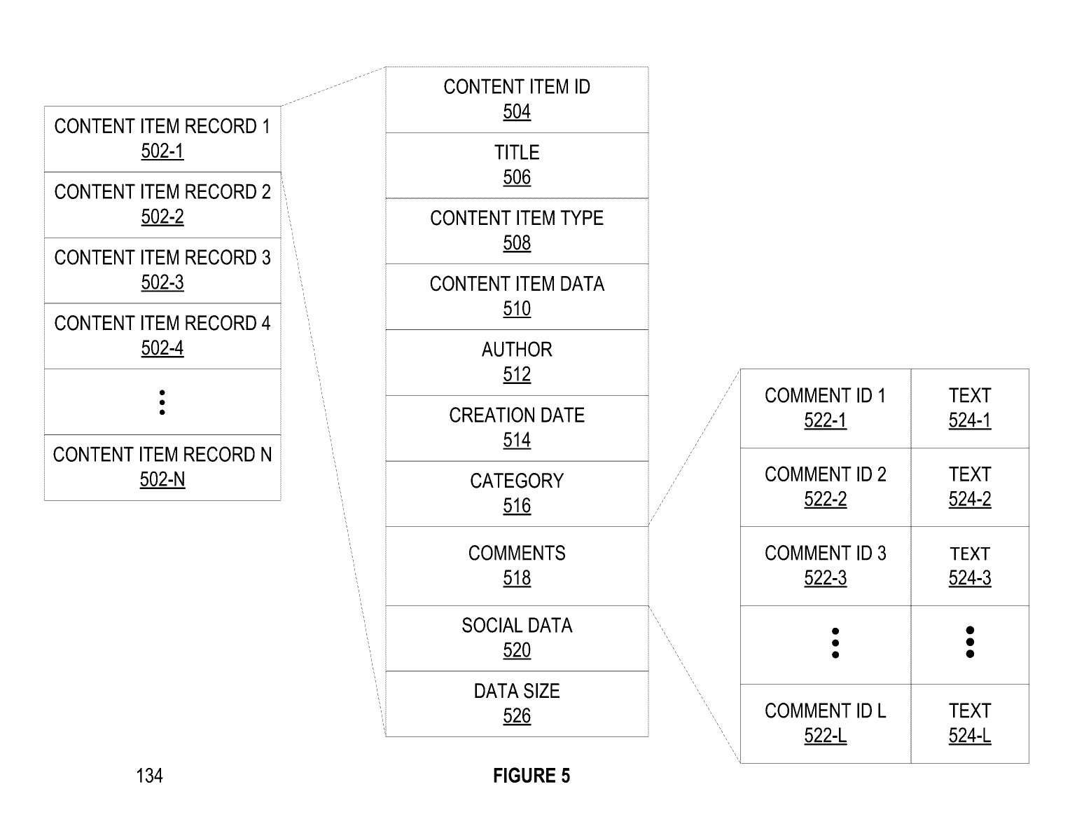

FIG. 5 depicts a block diagram of an exemplary data structure for the content item data 134 in accordance with some example embodiments. In accordance with some example embodiments, the content item data 134 includes a plurality of content item records 502-1 to 502-N, each of which corresponds to a specific content item stored for sharing on the social networking system 120 (FIG. 1).

In some example embodiments, a respective content item record 502 stores a unique content item ID 504 for identifying the content item, a title 506 for the content item (e.g., what the name of the content item is), a content item type 508 associated with the content item (e.g., video, text, image, and so on), content item data 510 (e.g., the actual data needed to display the content item), the author data 512 of the content item (e.g., the member who submitted the content item to the social networking system (e.g., system 120 in FIG. 1), the creation date 514 of the content item (e.g., when the content item is submitted to the social networking system (e.g., system 120 in FIG. 1)), the category information 516 of the content item including one or more topics associated with the content item and one or more related content items, comment 518 associated with the content item submitted by members of the social networking system (e.g., system 120 in FIG. 1), social data 520, and data size 526 (e.g., the size of the data content item).

In some example embodiments, a content item record 502 includes a list of comment identifiers (IDs) 522-1 to 522-L associated with the content item and the associated text content 524-1 to 524-L. Each comment ID 522 represents a specific comment associated with the content item. In some example embodiments, each comment is received from a particular member of the social networking system (e.g., system 120 in FIG. 1). In some example embodiments, the author of each comment is also stored with the comment ID 522. In some example embodiments, comments have a place in a hierarchical structure such that each comment is replying to another comment or to the content item directly. In some example embodiments, the data associated with the comments 518 also stores the hierarchical position of the comment relative to the other comments. In some example embodiments, the comment data also stores the number of likes, up-votes, shares, and follows that each comment has accrued.

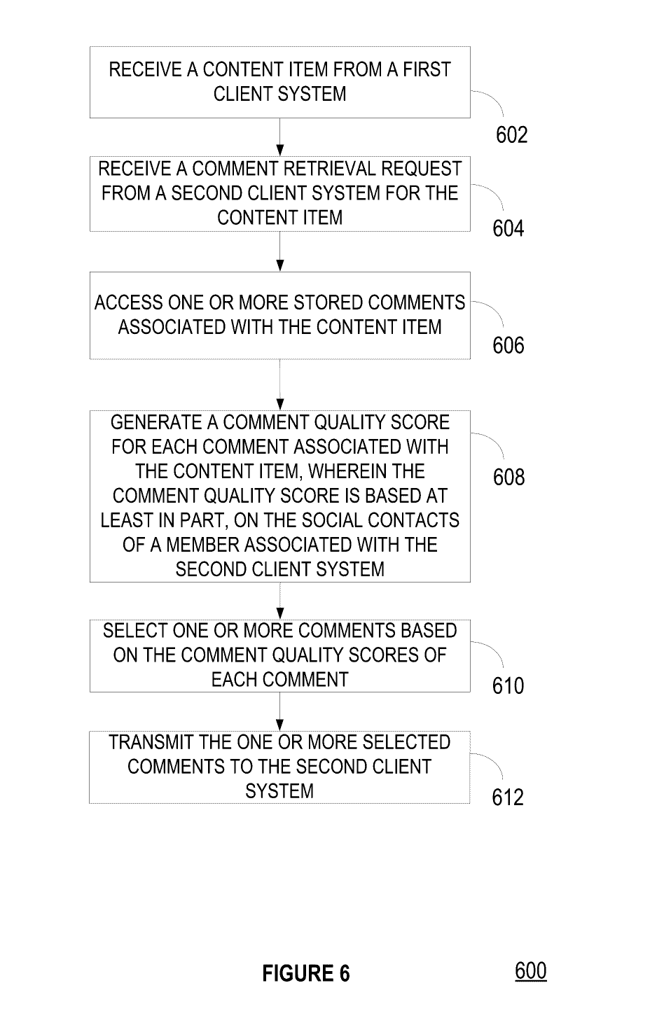

FIG. 6 is a flow diagram illustrating a method, in accordance with some example embodiments, for using large data sets to analyze member comments in a social networking system (e.g., system 120 in FIG. 1) environment. Each of the operations shown in FIG. 6 may correspond to instructions stored in a computer memory (e.g., memory 306) or a computer-readable storage medium. In some example embodiments, the method 600 described in FIG. 6 is performed by the social networking system (e.g., system 120 in FIG. 1).

In some example embodiments, the method 600 is performed at a social networking system (e.g., system 120 in FIG. 1) including one or more processors and memory 306 storing one or more programs for execution by the one or more processors.

The social networking system (e.g., system 120 in FIG. 1) receives (602) a content item from a first client system (e.g., client system 102 in FIG. 1). In some example embodiments, the content item is blog post, update or other text-based item. In other example embodiments, the content item is an image, a video, or an audio clip. In some example embodiments, the content item is stored in a database at a social networking system (e.g., system 120 in FIG. 1). In some example embodiments, the first client system (e.g., client system 102 in FIG. 1) has an associated member. For example, a member logs onto the social networking system (e.g., system 120 in FIG. 1) through the first client system (e.g., client system 102 in FIG. 1). Thus, all communication from the first client system (e.g., client system 102 in FIG. 1) is associated with the member logged into the first client system (e.g., client system 102 in FIG. 1).

In some example embodiments, the social networking system (e.g., system 120 in FIG. 1) receives (604) a comment retrieval request from a second client system, wherein the comment retrieval request is associated with a specific content item. For example, a member is viewing a content item through the social networking system (e.g., system 120 in FIG. 1). The member then clicks a link associated with the content item to request comments for the content item. In response to the link being clicked, the client system (e.g., client system 102 in FIG. 1) that the member is using sends a comment retrieval message to the social networking system (e.g., system 120 in FIG. 1).

In some example embodiments, in response to receiving the comment retrieval request from a second client system (e.g., client system 102 in FIG. 1), the social networking system (e.g., system 120 in FIG. 1) accesses (606) one or more comments associated with the content item. In some example embodiments, the comments are received from members of the social networking system (e.g., system 120 in FIG. 1) and stored in a database at the social networking system (e.g., system 120 in FIG. 1).

In some example embodiments, the social networking system (e.g., system 120 in FIG. 1) then generates (608) a comment quality score for each comment associated with the content item, wherein the comment quality score is based, at least in part, on the social contacts of a member associated with the second client system. For example, the social networking system (e.g., system 120 in FIG. 1) determines the author of each comment and, if that author is a social contact of the member associated with the second client system, the social networking system (e.g., system 120 in FIG. 1) increases the comment quality score for that comment. In this way, the comment quality scores can vary based on which members request comments and who their contacts are.

The social networking system (e.g., system 120 in FIG. 1) then selects (610) one or more comments based on the comment quality scores associated with each comment. For example, the social networking system (e.g., system 120 in FIG. 1) determines the amount of space available in the user interface to display comments and then selects a number of top comments that matches the available space.

In some example embodiments, the social networking system (e.g., system 120 in FIG. 1) transmits (612) the one or more selected comments to the second client system. The comments are then displayed on a display associated with the client system (e.g., client system 102 in FIG. 1)

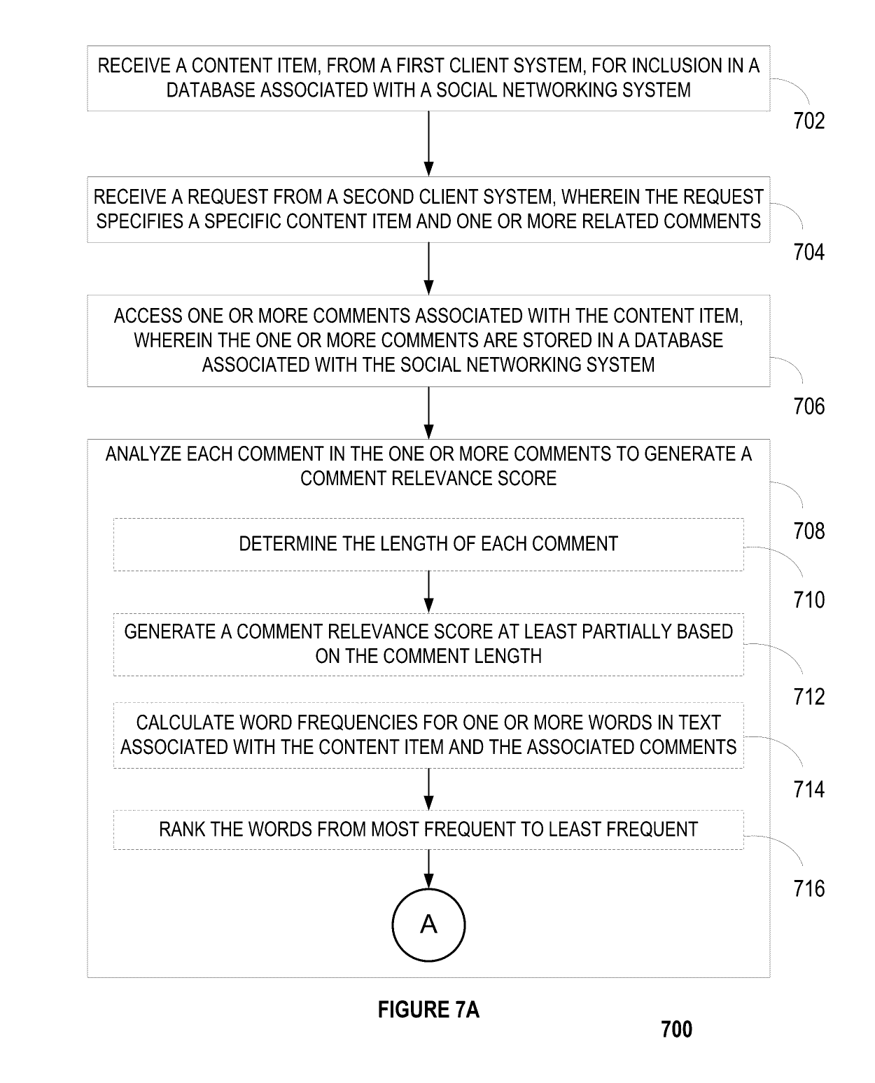

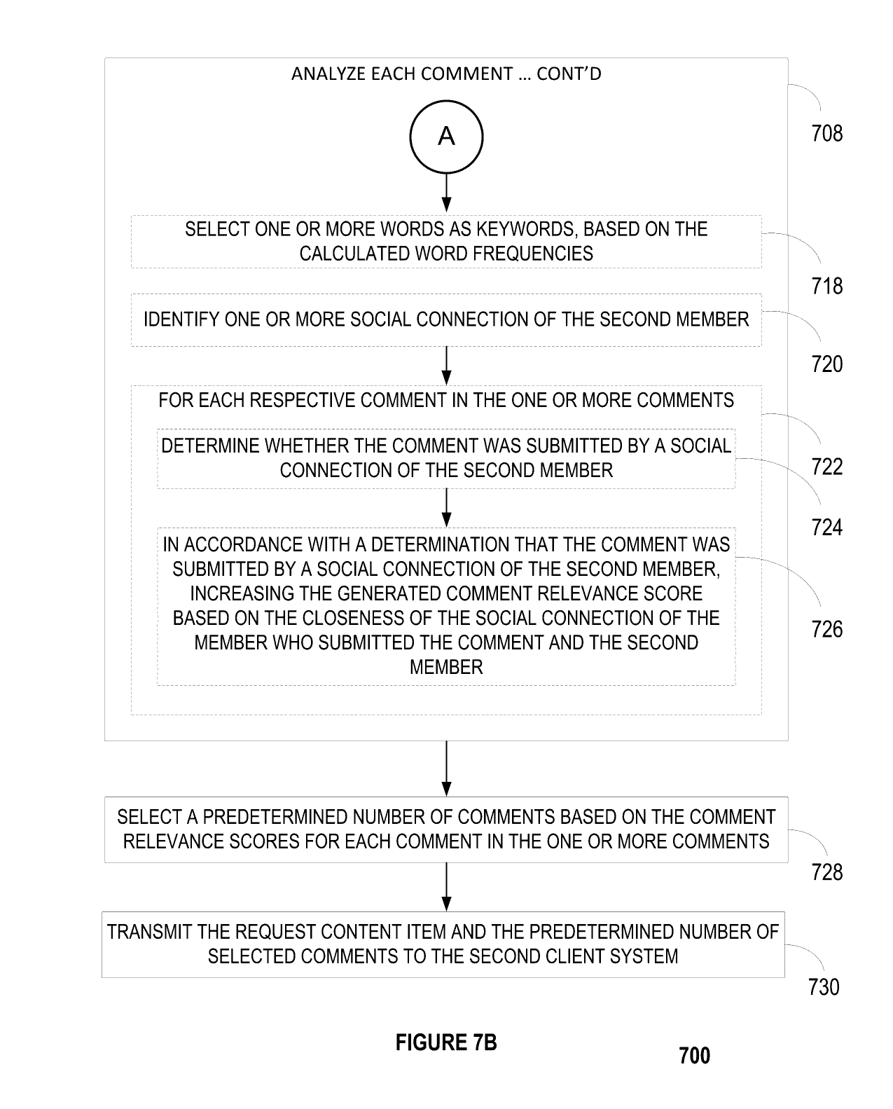

FIG. 7A is a flow diagram illustrating a method, in accordance with some example embodiments, for using large data sets to analyze member comments in a social networking system (e.g., system 120 in FIG. 1) environment. Each of the operations shown in FIG. 7A may correspond to instructions stored in a memory 306 or a computer-readable storage medium. Optional operations are indicated by dashed lines (e.g., boxes with dashed-line borders). In some embodiments, the method 700 described in FIG. 7A is performed by the social networking system (e.g., system 120 in FIG. 1). However, the method 700 can also be performed by any other suitable configuration of electronic hardware.

In some embodiments, the method 700 is performed at a social networking system (e.g., system 120 in FIG. 1) including one or more processors and memory 306 storing one or more programs for execution by the one or more processors.

In some example embodiments, the social networking system (e.g., system 120 in FIG. 1) receives (702) a content item, from a first client system, for inclusion in a database associated with a social networking system. In some example embodiments, the content item is included in a post on the social networking system. Content items include posts, updates, blogs, videos, images, songs, sounds, and so on.

In some example embodiments, the social networking system (e.g., system 120 in FIG. 1) receives one or comments from members of the social networking system. Each received comment is associated with a particular content item in the social networking system and has an associated author (e.g., the member who submits the comment).

In some example embodiments, each comment is stored in a database at the social networking system (e.g., system 120 in FIG. 1) and includes information about which content items the comment is associated with and which comment(s), if any, it is replying to.

In some example embodiments, the social networking system (e.g., system 120 in FIG. 1) receives (704) a request from a second client system, wherein the request specifies a specific content item and one or more related comments. For example, Member A views a video through the social networking system (e.g., system 120 in FIG. 1) and clicks on a “View Comments” link. In response, the client system (e.g., client system 102 in FIG. 1) that Member A is using then sends the comment retrieval request to the social networking system (e.g., system 120 in FIG. 1).

In some example embodiments, the first client system and the second client system are the same client system (e.g., the client system 102 in FIG. 1). In this way, the author of a content item (e.g., a blog post) can view comments on a content item they authored.

In some example embodiments, the social networking system (e.g., system 120 in FIG. 1) accesses (706) one or more comments associated with the content item, wherein the one or more comments are stored in a database associated with the social networking system (e.g., system 120 in FIG. 1). For example, the social networking system (e.g., system 120 in FIG. 1) retrieves all the comments associated with the content item from a database.

In some example embodiments, the social networking system (e.g., system 120 in FIG. 1) analyses (708) each comment in the one or more comments to generate a comment relevance score.

In some example embodiments, analyzing each comment in the one or more comments to generate a comment relevance score includes the social networking system (e.g., system 120 in FIG. 1) determining (710) the length of each comment. The social networking system (e.g., system 120 in FIG. 1) counts the number of words in each comment.

In some example embodiments, the social networking system (e.g., system 120 in FIG. 1) generates (712) a comment relevance score at least partially based on the comment length. In some example embodiments, medium length comments receive higher scores than short comments or very long comments.

In some example embodiments, analyzing each comment in the one or more comments to generate a comment relevance score further comprises aggregating a number of social gestures on each comment. Social gestures include any action a member can take through the social networking system to indicate approval or disapproval of the comment including but not limited to likes, sub-comments, follows, shares, and up-votes.

In some example embodiments, generating a comment relevance score for a respective comment also includes determining whether a social interaction was taken by a social contact of the member requesting one or more comments. For example, if Member A requests to see relevant comments on an article, the social networking system (e.g., system 120 in FIG. 1) determines which comments have been “liked” by the first degree social connections of Member A. Those comments received a higher relative comment relevance score than comments that have not been “liked” by a member that is socially connected to Member A.

In some example embodiments, the degree to which a comment receives a higher weighted comment relevance scores depends on the closeness of the social connection between the requesting member and the member that initiated the social gesture. For example, a comment that is liked by a member that is a first degree social connection (e.g., directly connected) of Member A will receive a higher score (all other things being equal) than a comment that is “liked” by a third degree social connection of Member A.

In some example embodiments, the closeness of a social connection is determined based on the number of connections between the first member (e.g., the member requesting the comments and for whom they are being ranked) and the second member (e.g., the author of the comment). In some example embodiments, the closeness of social connections between two members by determining the number of overlapping attributes that exist between the two members. For example, if two members both attended the same university or are located in the same city they will receive a higher closeness score than two members without these similarities, all else being equal.

In some example embodiments, the social networking system (e.g., system 120 in FIG. 1) generates a comment relevance score for a respective comment based at least partially on a number of positive social gestures associated with that comment. For example, a comment that has received many “likes” will generally receive a higher comment relevance score than a comment with very few likes. In other example embodiments, positive social gestures can be determined based on parsing comments and analyzing the words in them. For example, words like “good points,” “thoughtful,” and “well-reasoned” might indicate that the comment is a positive social interaction whereas negative words (or words with negative connotations) would not be considered a positive social interaction. In some example embodiments, each possible interaction can be assigned a value based on how positive it is, (e.g., sharing or linking a comment is perhaps more positive than just “Liking” it) and these rankings can be used to determine the amount of positive social interaction for each comment.

In some example embodiments, analyzing each comment in the one or more comments to generate a comment relevance score includes the social networking system (e.g., system 120 in FIG. 1) calculating (714) word frequencies for one or more words in text associated with the content item and the associated comments. The social networking system (e.g., system 120 in FIG. 1) then ranks (716) the words from most frequent to least frequent. In some example embodiments, very common words are omitted, particularly if the words are articles or other words without significant meaning (e.g., “the”, “and”, “a”, and so on).

FIG. 7B is a flow diagram further illustrating the method 700, in accordance with some example embodiments, for using large data sets to analyze member comments in a social networking system (e.g., system 120 in FIG. 1) environment. Each of the operations shown in FIG. 7B may correspond to instructions stored in a computer memory or a computer-readable storage medium. Optional operations are indicated by dashed lines (e.g., boxes with dashed-line borders). In some embodiments, the method 700 described in FIG. 7B is performed by the social networking system (e.g., system 120 in FIG. 1). However, the method 700 described can also be performed by any other suitable configuration of electronic hardware.

In some embodiments the method 700 is performed at a social networking system (e.g., system 120 in FIG. 1) including one or more processors and memory storing one or more programs for execution by the one or more processors. In some example embodiments, the operations illustrated in FIG. 7B follow, or are a part of, the operations illustrated in FIG. 7A.

In some example embodiments, the social networking system (e.g., system 120 in FIG. 1) selects (718) one or more words as keywords, based on the calculated word frequencies. In some example embodiments, the comment relevance score for a respective comment is based at least partially on the number of keywords included in the respective comment. In some example embodiments, the keywords are generated based only on those comments from one or more members who are connected in the social graph to the requesting members. In this way, even the keywords can be personalized based on a member's social circle.

In some example embodiments, the social networking system (e.g., system 120 in FIG. 1) identifies (720) one or more social connections of the second member.

In some example embodiments, the social networking system (e.g., system 120 in FIG. 1), for each respective comment in the one or more comments (722), determines (724) whether the comment was submitted by a social connection of the second member.

In some example embodiments, in accordance with a determination that the comment was submitted by a social connection of the second member, the social networking system (e.g., system 120 in FIG. 1) increases (726) the generated comment relevance score based on the closeness of the social connection of the member who submitted the comment and the second member. In some example embodiments, the social connections of the first member (e.g., the original author of the content item) are also given increased comment relevance scores. This can be true even when the first member is not the requesting member.

In some example embodiments, the ultimate comment relevance score is the aggregation of multiple sub-scores that each reflect a separate aspect of quality or relevance for a comment. For example, the social networking system (e.g., system 120 in FIG. 1) generates a sub-score for comment length (with medium length comments receiving higher sub-scores than short or very long comments), a sub-score for the number of keywords in a comments (e.g., more keywords is generally correlated with a higher sub-score), and a sub-score for the number and type of social interactions (e.g., more “likes” and sub-comments result in a higher score).

In some example embodiments, the social networking system (e.g., system 120 in FIG. 1) generates a plurality of sub-scores for including at least a sub-score based on comment length, a sub-score based on the number of keywords in a respective comment, a sub-score based on a social connection between an author of the comment and a second member associated with the second client system, and a sub-score for a number of positive social interactions with the comment.

In some example embodiments, the social networking system (e.g., system 120 in FIG. 1) the social networking system (e.g., system 120 in FIG. 1) gives each respective sub-score a sub-score weight (e.g., how much each sub-score affects he final score). The social networking system (e.g., system 120 in FIG. 1) generates the comment relevance score for a respective comment by combining the plurality of sub-scores based upon the weight for each sub-score. In some example embodiments, the social networking system (e.g., system 120 in FIG. 1) the weight for each respective sub-score is based on preferences received from of the second member. For example, the member wants to prioritize the comments of his or her social connections and instructs the social networking system (e.g., system 120 in FIG. 1) to make the social connectedness sub-core count for 80% of the total comment relevance score. Another member weighs positive social interactions as the highest priority.

Thus, a member may prefer to have comments rated based on network, or alternatively, subject matter, or, popularity (based on gestures, etc.) and the comment relevance (and therefore comment rankings) can be used to reflect those preferences.

In some example embodiments, the social networking system (e.g., system 120 in FIG. 1) then aggregates or creates a composite score based on the one or more sub-scores (e.g. component scores). In some example embodiments, certain sub-scores are more highly weighted than others. In other example embodiments, certain sub-scores are not used at all, based on comment scoring preferences of an organization or an individual.

In some example embodiments, the social networking system (e.g., system 120 in FIG. 1) selects (728) a predetermined number of comments based on the comment relevance scores for each comment in the one or more comments. The social networking system (e.g., system 120 in FIG. 1) transmits (730) the requested content item and the predetermined number of selected comments to the second client system.

### Software Architecture

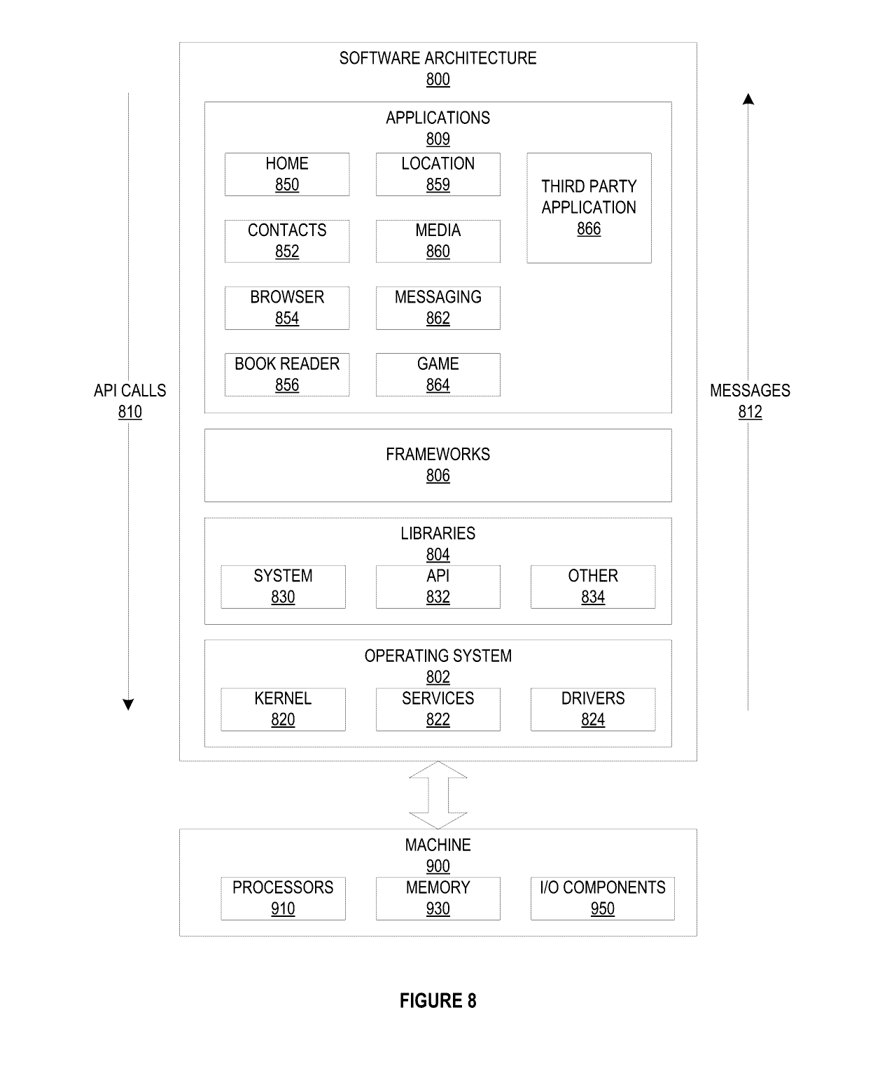

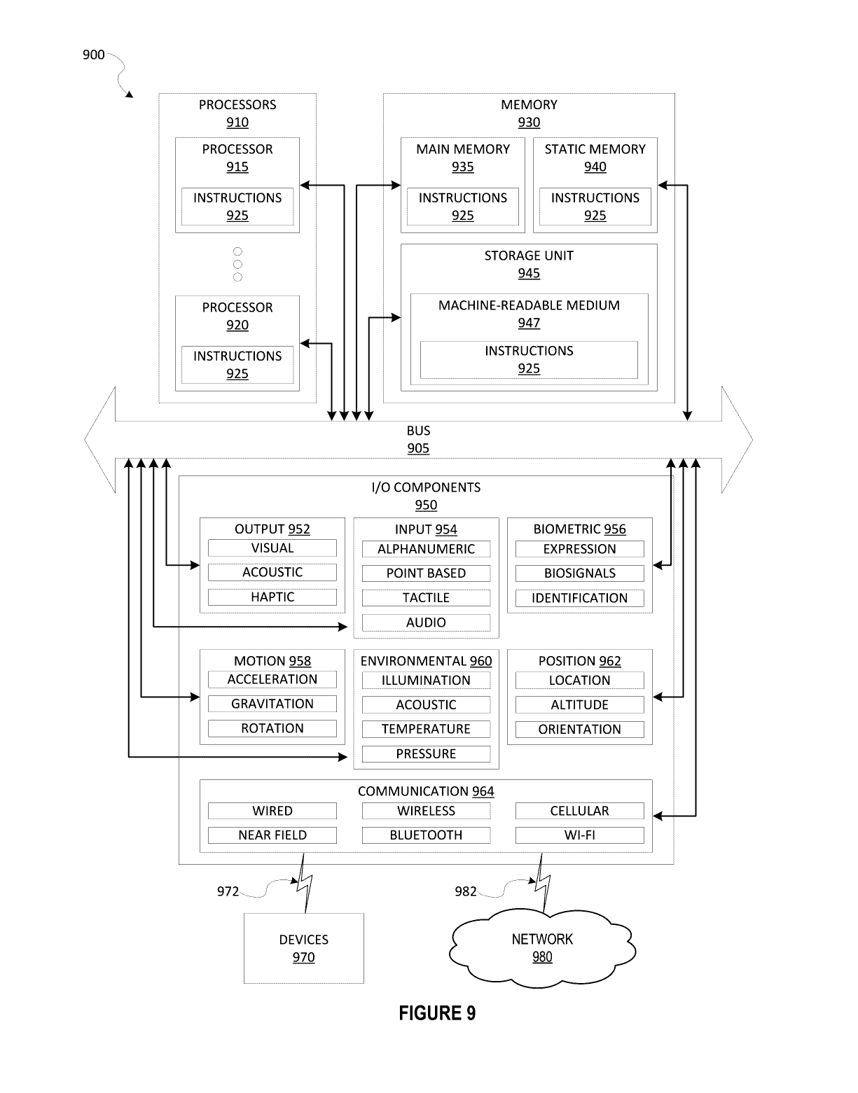

FIG. 8 is a block diagram illustrating an architecture of software 800, which may be installed on any one or more of the devices of FIG. 1. FIG. 8 is merely a non-limiting example of an architecture of software 800 and it will be appreciated that many other architectures may be implemented to facilitate the functionality described herein. The software 800 may be executing on hardware such as machine 900 of FIG. 9 that includes processors 910, memory 930, and I/O components 950. In the example architecture of FIG. 8, the software 800 may be conceptualized as a stack of layers where each layer may provide particular functionality. For example, the software 800 may include layers such as an operating system 802, libraries 804, frameworks 806, and applications 809. Operationally, the applications 809 may invoke API calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 809. The libraries 804 may include system libraries 830 (e.g., C standard library) that may provide functions such as memory allocation functions, string manipulation functions, mathematic functions, and the like. In addition, the libraries 804 may include API libraries 832 such as media libraries (e.g., libraries to support presentation and manipulation of various media formats such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 804 may also include a wide variety of other libraries 834 to provide many other APIs to the applications 809.

The frameworks 806 may provide a high-level common infrastructure that may be utilized by the applications 809. For example, the frameworks 806 may provide various graphical user interface (GUI) functions, high-level resource management, high-level location services, and so forth. The frameworks 806 may provide a broad spectrum of other APIs that may be utilized by the applications 809, some of which may be specific to a particular operating system 802 or platform.

The applications 809 include a home application 850, a contacts application 852, a browser application 854, a book reader application 856, a location application 859, a media application 860, a messaging application 862, a game application 864, and a broad assortment of other applications such as third party application 866. In a specific example, the third party application 866 (e.g., an application developed using the Android™ or iOS™ software development kit (SDK) by an entity other than the vendor of the particular platform) may be mobile software running on a mobile operating system 802 such as iOS™, Android™, Windows® Phone, or other mobile operating systems 802. In this example, the third party application 866 may invoke the API calls 810 provided by the mobile operating system 802 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 925 (e.g., software 800, a program, an application, an applet, an app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a (PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 925, sequentially or otherwise, that specify actions to be taken by machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 915 and processor 920, which may execute instructions 925. The term “processor” is intended to include multi-core processors 910 that may comprise two or more independent processors 915, 920 (also referred to as “cores”) that may execute instructions 925 contemporaneously. Although FIG. 9 shows multiple processors 910, the machine 900 may include a single processor 910 with a single core, a single processor 910 with multiple cores (e.g., a multi-core process), multiple processors 910 with a single core, multiple processors 910 with multiples cores, or any combination thereof.

The memory 930 may include a main memory 935, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 935, within the static memory 940, within at least one of the processors 910 (e.g., within the processor's cache memory), or any suitable combination thereof, during execution thereof by the machine 900. Accordingly, the main memory 935, static memory 940, and the processors 910 may be considered as machine-readable media 947.

As used herein, the term “memory” refers to a machine-readable medium 947 able to store data temporarily or permanently and may be taken to include, but not be limited to, random-access memory (RAM), read-only memory (ROM), buffer memory, flash memory, and cache memory. While the machine-readable medium 947 is shown, in an example embodiment, to be a single medium, the term “machine-readable medium” should be taken to include a single medium or multiple media (e.g., a centralized or distributed database, or associated caches and servers) able to store instructions 925. The term “machine-readable medium” shall also be taken to include any medium, or combination of multiple media, that is capable of storing instructions (e.g., instructions 925) for execution by a machine (e.g., machine 900), such that the instructions 925, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 962 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 and/or devices 970 via coupling 982 and coupling 972, respectively. For example, the communication components 964 may include a network interface component or other suitable device to interface with the network 980. In further examples, communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine 900 and/or any of a wide variety of peripheral devices (e.g., a peripheral device coupled via a USB).

Moreover, the communication components 964 may detect identifiers and/or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 964 such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., HyperText Transfer Protocol (HTTP)). Similarly, the instructions 925 may be transmitted and/or received using a transmission medium via the coupling 972 (e.g., a peer-to-peer coupling) to devices 970. The term “transmission medium” shall be taken to include any intangible medium that is capable of storing, encoding, or carrying instructions 925 for execution by the machine 900, and includes digital or analog communications signals or other intangible medium to facilitate communication of such software 800.

Furthermore, the machine-readable medium 947 is non-transitory (in other words, not having any transitory signals) in that it does not embody a propagating signal. However, labeling the machine-readable medium 947 as “non-transitory” should not be construed to mean that the medium is incapable of movement; the medium should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A method comprising:
receiving a content item, from a first client system, for inclusion in a first database associated with a social networking system;
receiving a request from a second client system, wherein the request specifies a specific content item wherein the specific content item has one or more associated comments;
accessing one or more comments associated with the content item, wherein the one or more comments are stored in a second database associated with the social networking system;
analyzing each comment in the one or more comments to generate a comment relevance score, wherein the analyzing a respective comment includes:
identifying one or more social connections of the second member;
identifying one or more social interactions with the respective comment including one or more of likes, sub-comments, follows, and up-votes;
determining whether at least one of the social interactions associated with the respective comment were submitted by a social connection of the second member; and
in accordance with a determination that at least one of the social interactions with the respective comment were submitted by a social connection of the second member, increasing the generated comment relevance score based on a closeness of the social connection of the member who submitted the social interaction and the second member; and
selecting a predetermined number of comments based on the comment relevance score for each comment in the one or more comments; and
transmitting the requested content item and the predetermined number of selected comments to the second client system.

2. The method of claim 1, wherein analyzing each comment in the one or more comments to generate a comment relevance score includes:
determining a length of each comment; and
generating the comment relevance score for each comment at least partially based on the comment length.

3. The method of claim 1, wherein analyzing each comment in the one or more comments to generate the comment relevance score includes:
calculating word frequencies for one or more words in text associated with the content item and the related comments;
ranking the words from most frequent to least frequent; and
selecting one or more words as keywords based on the calculated word frequencies.

4. The method of claim 3, wherein analyzing each comment in the one or more comments to generate the comment relevance score includes generating a comment relevance score for a respective comment based at least partially on a number of keywords included in the respective comment.

5. The method of claim 1, wherein there is a first member of the social networking system associated with the first client system and a second member of the social networking system associated with the second client system and wherein analyzing each comment in the one or more comments to generate the comment relevance score includes:
identifying one or more social connection of the second member;
for each respective comment in the one or more comments:
determining whether the comment was submitted by a social connection of the second member; and
in accordance with a determination that the comment was submitted by a social connection of the second member, increasing the generated comment relevance score based on a closeness of the social connection of the member who submitted the comment and the second member.

6. (canceled)

7. (canceled)

8. The method of claim 1, wherein analyzing each comment in the one or more comments to generate a comment relevance score further comprises:
generating a plurality of sub-scores for including at least a sub-score based on comment length, a sub-score based on the number of keywords in a respective comment, a sub-score based on a social connection between an author of the comment and a second member associated with the second client system, and a sub-score for a number of positive social interactions with the comment;
giving each respective sub-score a sub-score weight; and
generating the comment relevance score for a respective comment by combining the plurality of sub-scores based upon the weight for each sub-score.

9. The method of claim 8, wherein the weight for each respective sub-score is based on preferences received from of the second member.

10. The method of claim 1, wherein the content item is included in a post on the social networking system.

11. The method of claim 1, wherein the first client system and the second client system are the same client system.

12. A system comprising:
one or more processors;
memory; and
one or more programs stored in the memory, the one or more programs comprising instructions for:
receiving a content item, from a first client system, for inclusion in a first database associated with a social networking system;
receiving a request from a second client system, wherein the request specifies a specific content item and one or more related comments;
accessing one or more comments associated with the content item, wherein the one or more comments are stored in a second database associated with the social networking system;
analyzing each comment in the one or more comments to generate a comment relevance score, wherein the analyzing a respective comment includes:
identifying one or more social connections of the second member;
identifying one or more social interactions with the respective comment including one or more of likes, sub-comments, follows, and up-votes;
determining whether at least one of the social interactions associated with the respective comment were submitted by a social connection of the second member; and
in accordance with a determination that at least one of the social interactions with the respective comment were submitted by a social connection of the second member, increasing the generated comment relevance score based on a closeness of the social connection of the member who submitted the social interaction and the second member; and
selecting a predetermined number of comments based on the comment relevance score for each comment in the one or more comments; and
transmitting the requested content item and the predetermined number of selected comments to the second client system.

13. The system of claim 12, wherein the content item is included in a post on the social networking system.

14. The system of claim 12, wherein analyzing each comment in the one or more comments to generate a comment relevance score includes:
determining a length of each comment; and
generating the comment relevance score for each comment at least partially based on the comment length.

15. The system of claim 12, wherein analyzing each comment in the one or more comments to generate the comment relevance score includes:
calculating word frequencies for one or more words in text associated with the content item and the related comments;
ranking the words from most frequent to least frequent; and
selecting one or more words as keywords based on the calculated word frequencies.

16. A non-transitory computer readable storage medium storing one or more programs for execution by one or more processors, the one or more programs comprising instructions for:
receiving a content item, from a first client system, for inclusion in a first database associated with a social networking system;
receiving a request from a second client system, wherein the request specifies a specific content item and one or more related comments;
accessing one or more comments associated with the content item, wherein the one or more comments are stored in a second database associated with the social networking system;
analyzing each comment in the one or more comments to generate a comment relevance score, wherein the analyzing a respective comment includes:
identifying one or more social connections of the second member;
identifying one or more social interactions with the respective comment including one or more of likes, sub-comments, follows, and up-votes;
determining whether at least one of the social interactions associated with the respective comment were submitted by a social connection of the second member; and
in accordance with a determination that at least one of the social interactions with the respective comment were submitted by a social connection of the second member, increasing the generated comment relevance score based on a closeness of the social connection of the member who submitted the social interaction and the second member;
selecting a predetermined number of comments based on the comment relevance score for each comment in the one or more comments; and
transmitting the requested content item and the predetermined number of selected comments to the second client system.

17. The non-transitory computer readable storage medium of claim 16, wherein the content item is included in a post on the social networking system.

18. The non-transitory computer readable storage medium of claim 16, wherein the first client system and the second client system are the same client system.

19. The non-transitory computer readable storage medium of claim 16, wherein analyzing each comment in the one or more comments to generate a comment relevance score includes:
determining a length of each comment; and
generating the comment relevance score for each comment at least partially based on the comment length.

20. The non-transitory computer readable storage medium of claim 16, wherein analyzing each comment in the one or more comments to generate the comment relevance score includes:
calculating word frequencies for one or more words in text associated with the content item and the related comments;
ranking the words from most frequent to least frequent; and
selecting one or more words as keywords based on the calculated word frequencies.
